(19) United States
(12) Patent Application Publication
(10) Pub. No.: US 2017/0314649 A1
(43) Pub. Date: Nov. 2, 2017

(54) VEHICLE POWER TRANSMISSION SYSTEM AND MANUFACTURING METHOD FOR THE SAME

(71) Applicant: TOYOTA JIDOSHA KABUSHIKI KAISHA, Toyota-shi (JP)

(72) Inventors: Yosuke MICHIKOSHI, Toyota-shi (JP); Masashi IKEMURA, Toyota-shi (JP)

(73) Assignee: TOYOTA JIDOSHA KABUSHIKI KAISHA, Toyota-shi (JP)

(21) Appl. No.: 15/492,353

(22) Filed: Apr. 20, 2017

(30) Foreign Application Priority Data
Apr. 28, 2016 (JP) 2016-091153

(51) Int. Cl. F16H 3/66; F16H 57/08; B23P 15/00

(52) U.S. Cl. CPC F16H 3/663; B23P 15/00; F16H 57/08; F16H 2200/2046; F16H 2200/201; F16H 2057/087; B23P 2700/50; F16H 2200/2066; F16H 2200/2082; F16H 2200/006

(57) ABSTRACT

When a third sun gear is fitted into a fitting hole of a clutch drum, external circumferential spline teeth and internal circumferential spline teeth that configure a spline-fitted part start meshing with each other before a tolerance ring comes into contact with the third sun gear and the clutch drum. Accordingly, the external circumferential spline teeth and the internal circumferential spline teeth mesh with each other, thereby centering the third sun gear and the clutch drum, thus accurately assembling the third sun gear and the clutch drum without causing eccentricity thereof

INCORPORATION BY REFERENCE

The disclosure of Japanese Patent Application No. 2016-091153 filed on Apr. 28, 2016 including the specification, drawings and abstract is incorporated herein by reference in its entirety.

### BACKGROUND

### 1. Technical Field

The present disclosure relates to a vehicle power transmission system equipped with a spline-fitted part that is formed by spline-fitting a first rotary body and a second rotary body to each other, and also to a manufacturing method for the same.

### 2. Description of Related Art

There have been known structures in which first rotary bodies are fitted in fitting holes formed in second rotary bodies, and tolerance rings are provided between outer circumferential surfaces of the first rotary bodies and inner circumferential surfaces of the second rotary bodies. Japanese Patent Application Publication No. 2012-52638 discloses a structure in which a tolerance ring 10 is provided between both shaft members S1, S2 that configure a dual-shaft shape. The tolerance ring 10 of JP 2012-52638 A allows axial centers of both the shaft members S1, S2 to coincide with each other, functions as a torsion reducing mechanism, and also functions as a torque limiter if a predetermined torsion torque or more is transmitted thereto.

### SUMMARY

Meanwhile, in the above disclosure, it is mentioned that the tolerance ring is provided between both the shaft members, but there is no mention about assembly thereof. For example, in the case in which some of rotary elements of a planetary gear unit configuring a transmission are spline-fitted to rotary elements of another planetary gear unit, some of rotary elements configuring a clutch (or a brake), or some of non-rotary members, and a tolerance ring is disposed near these rotary elements, a space in the vicinity of the spline-fitted part is limited in light of demands on size reduction of an apparatus; therefore, it becomes difficult to center a rotational axis of the tolerance ring during assembly thereof, and thus might be assembled while the rotational axis thereof is eccentric.

The present disclosure provides a vehicle power transmission system including a spline-fitted part and a tolerance ring that are provided between a first rotary body and a second rotary body, wherein the first rotary body and the second rotary body can be so assembled as no to be eccentric while being assembled.

In a manufacturing method for a vehicle power transmission system of the present embodiment, the vehicle power transmission system includes: a first rotary body configured to rotate around an axial line; and a second rotary body including a fitting hole into which one end portion of the first rotary body is fitted, the second rotary body being configured to rotate around the axial line, the first rotary body and the second rotary body being configured such that external circumferential teeth provided on an outer circumferential surface of the first rotary body and internal circumferential teeth provided on an inner circumferential surface of the fitting hole are spline-fitted to each other at a spline-fitted part. The manufacturing method includes: disposing a tolerance ring at a position closer to an opening of the fitting hole than to the spline-fitted part in a forward direction of assembling the second rotary body to the first rotary body when the first rotary body is fitted into the fitting hole of the second rotary body; and bringing the tolerance ring to come into contact with the first rotary body and the second rotary body after the external circumferential teeth of the first rotary body and the internal circumferential teeth of the second rotary body mesh with each other, in a transitional state in which the first rotary body is fitted into the fitting hole of the second rotary body.

According to the manufacturing method of the vehicle power transmission system in the present embodiment, when the first rotary body is fitted into the fitting hole of the second rotary body, the external circumferential teeth and the internal circumferential teeth that configure the spline-fitted part start meshing with each other before the tolerance ring comes into contact with the first rotary body and the second rotary body. Therefore, even if there is no space around the spline-fitted part and machining for centering is difficult to be carried out, the external circumferential teeth and the internal circumferential teeth mesh with each other, thereby centering the first rotary body and the second rotary body. Accordingly, it is possible to carry out an accurate assembly of the first rotary body and the second rotary body without causing eccentric thereof.

A vehicle power transmission system of the present embodiment includes: a first rotary body configured to rotate around an axial line; a second rotary body including a fitting hole into which one end portion of the first rotary body is fitted, the second rotary body being configured to rotate around the axial line, the first rotary body and the second rotary body being configured such that external circumferential teeth provided on an outer circumferential surface of the first rotary body and internal circumferential teeth provided on an inner circumferential surface of the fitting hole are spline-fitted to each other at a spline-fitted part; and a tolerance ring provided between the outer circumferential surface of the first rotary body and an inner circumferential surface of the second rotary body, the tolerance ring being located at a position closer to an opening of the fitting hole than to the spline-fitted part in the axial line direction, and a length in the axial line direction of a part where the external circumferential teeth and the internal circumferential teeth overlap each other as viewed from a radial direction being longer than a length in the axial line direction of the outer circumferential surface of the first rotary body or the inner circumferential surface of the second rotary body that come into contact with the tolerance ring.

According to the vehicle power transmission system of the present embodiment, the length in the axial line direction of the part where the external circumferential teeth of the first rotary body and the internal circumferential teeth of the second rotary body overlap each other as viewed from the radial direction after the assembly is longer than the length in the axial line direction of the outer circumferential surface of the first rotary body or the inner circumferential surface of the second rotary body that come into contact with the tolerance ring in the assembly-transitional state; thus, when the first rotary body is fitted into the fitting hole of the second rotary body, the external circumferential teeth and the internal circumferential teeth that configure the spline-fitted part start meshing with each other before the tolerance ring comes into contact with the outer circumferential surface of the first rotary body or the inner circumferential surface of the second rotary body. Therefore, even if there is no space around the spline-fitted part and machining for centering is difficult to be carried out, the external circumferential teeth and the internal circumferential teeth mesh with each other, thereby carrying out the centering thereof. Accordingly, it is possible to carry out an accurate assembly of the first rotary body and the second rotary body without causing eccentric thereof.

The tolerance ring may be housed in an annular groove provided in the inner circumferential surface of the fitting hole of the second rotary body.

Because the tolerance ring is housed in the annular groove formed in the inner circumferential surface of the fitting hole of the second rotary body, no annular groove is formed in the first rotary body. Accordingly, since the annular groove is formed in the first rotary body, the wall thickness of the first rotary body is prevented from becoming thinner, and thus suppressing decrease in strength of the first rotary body. The annular groove formed in the second rotary body is formed at a position located closer to the opening of the fitting hole than to the spline-fitted part, and thus almost no torque is transmitted to the part where the annular groove is formed. Accordingly, even if the annular groove is formed in the second rotary body, decrease in strength of the second rotary body causes no problem.

The vehicle power transmission system may include: a first planetary gear unit; a second planetary gear unit; and a third planetary gear unit, the first planetary gear unit, the second planetary gear unit, and the third planetary gear unit may be configured to rotate around a common axial line, the second planetary gear unit and the third planetary gear unit may constitute a ravigneaux planetary gear including a carrier that serves as a carrier of the second planetary gear and a carrier of the third planetary gear and a ring gear that serves as a ring gear of the second planetary gear and a ring gear of the third planetary gear, a clutch may be provided between a ring gear of the first planetary gear unit and a sun gear of the third planetary gear unit, the spline-fitted part may be provided between the sun gear and a clutch drum of the clutch, the first rotary body may be the sun gear, and the second rotary body may be the clutch drum.

According to the aforementioned vehicle power transmission system, the length in the axial line direction of the part where the external circumferential teeth of the first rotary body and the internal circumferential teeth of the second rotary body overlap each other as viewed from the radial direction after the assembly is longer than the length in the axial line direction of the outer circumferential surface of the first rotary body or the inner circumferential surface of the second rotary body that come into contact with the tolerance ring in the assembly-transitional state; thus, when the first rotary body is fitted into the fitting hole of the second rotary body, the external circumferential teeth and the internal circumferential teeth that configure the spline-fitted part start meshing with each other before the tolerance ring comes into contact with the outer circumferential surface of the first rotary body or the inner circumferential surface of the second rotary body. Therefore, even if there is no space around the spline-fitted part and machining for centering is difficult to be carried out, the external circumferential teeth and the internal circumferential teeth mesh with each other, thereby carrying out the centering thereof. Accordingly, it is possible to carry out an accurate assembly of the first rotary body and the second rotary body without causing eccentric thereof.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view of an essential part of a vehicle power transmission system to which the present disclosure is applied;

FIG. 2 is an engagement operation table showing combinations of clutches and brakes that establish respective shift positions of an automatic transmission;

FIG. 3 is a cross-sectional view showing a part of the automatic transmission of FIG. 1;

FIG. 4 is an enlarged cross-sectional view enlarging a vicinity of a coupled part between a sun gear and a clutch drum in FIG. 3;

FIG. 5 is a view of a tolerance ring of FIG. 4 as viewed from an arrow A direction;

FIG. 6 is a view showing relative positions of the sun gear and the clutch drum of

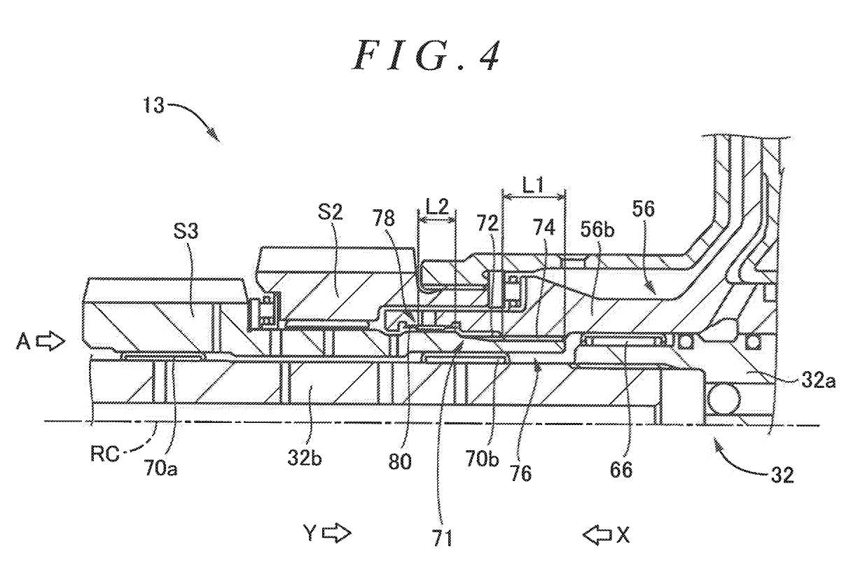

FIG. 4 in an assembly-transitional state thereof;

FIG. 7 is another view showing the relative positions of the sun gear and the clutch drum of FIG. 4 in the assembly-transitional state thereof;

FIG. 8 is a flowchart explaining assembly steps of assembling the clutch drum to the sun gear; and

FIG. 9 is a cross-sectional view explaining a structure of a coupled part between a sun gear and a clutch drum included in a vehicle power transmission system as another embodiment of the present disclosure.

### DETAILED DESCRIPTION OF EMBODIMENTS

Hereinafter, embodiments of the present disclosure will be described in details with reference to drawings. In the following embodiments, the drawings will be appropriately simplified or deformed, and the dimensional ratio, the shape and the like of each portion will not always be drawn accurately.

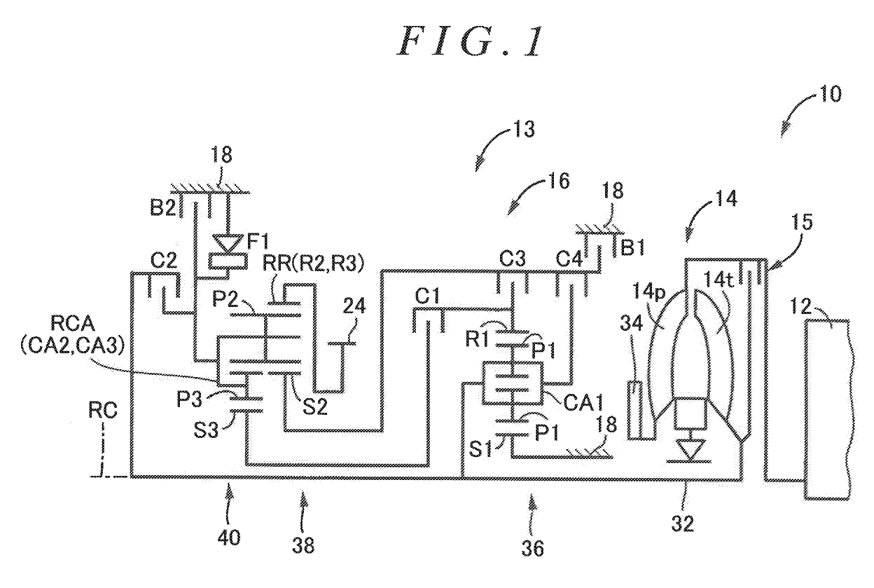

FIG. 1 is a view of an essential part of a vehicle drive system 10 to which the present disclosure is applied. The vehicle drive system is configured to include an engine 12 and a vehicle power transmission system 13. The vehicle power transmission system 13 is configured to include a torque converter 14 and an automatic transmission 16. Each of the torque converter 14 and the automatic transmission 16 is arranged to be symmetric relative to a center line (axial line RC), and an illustration of lower half parts thereof from this axial line RC is omitted in FIG. 1. The axial line RC in FIG. 1 is a rotational axial center (rotational center) of each of the engine 12, the torque converter 14, and the automatic transmission 16.

In FIG. 1, the torque converter 14 is so arranged as to be rotatable around the axial line RC, and includes: a pump impeller 14p coupled to the engine 12; and a turbine wheel 14t coupled to a transmission input shaft 32 that is an input rotary member of the automatic transmission 16. A mechanical-type oil pump 34 is coupled to the pump impeller 14p, and this oil pump 34 generates an operational hydraulic pressure used for a transmission control on the automatic transmission 16, and for supplying a lubrication oil to each part of a power transmission path of the automatic transmission 16. The torque converter 14 is provided with a lockup clutch 15 that directly couples the pump impeller 14p to the turbine wheel 14t.

The automatic transmission 16 is a planetary-gear-type multistep transmission configuring a part of the power transmission path from the engine 12 to each not-shown driven wheel, and functioning as a stepped automatic transmission that forms multiple gear positions (shift positions) having different gear ratios (transmission gear ratios) by selectively engaging any one of multiple friction engagement devices (a first clutch C1 to a fourth clutch C4, a first brake B1, and a second brake B2) and a one-way clutch F1. For example, the automatic transmission 16 is a stepped transmission that carries out a so-called clutch-to-clutch transmission that is often used for a known vehicle. This automatic transmission 16 includes: a double-pinion-type first planetary gear unit 36; and a single-pinion-type second planetary gear unit 38 and a double-pinion-type third planetary gear unit 40 that are configured into a ravigneaux-type on the same axial line (on the axial line RC), changes rotational speed of the transmission input shaft 32, and outputs this rotation from a transmission output shaft 24.

The first planetary gear unit 36 includes a first sun gear S1 that is an external gear, a first ring gear R1 that is an internal gear so arranged as to be concentric to the first sun gear S1, a first pinion gear P1 composed of a pair of gears that mesh with the first sun gear S1 and the first ring gear R1, and a first carrier CA1 that supports the first pinion gear P1 in a manner as to allow rotation of the first pinion gear P1 around its own axis as well as an orbital revolution thereof.

The second planetary gear unit 38 includes a second sun gear S2 that is an external gear, a second ring gear R2 that is an internal gear so arranged as to be concentric to the second sun gear S2, a second opinion gear P2 that meshes with the second sun gear S2 and the second ring gear R2, and a second carrier CA2 that supports the second pinion gear P2 in a manner as to allow rotation of the second pinion gear P2 around its own axis as well as an orbital revolution thereof.

The third planetary gear unit 40 includes a third sun gear S3 that is an external gear, a third ring gear R3 that is an internal gear so arranged as to be concentric to the third sun gear S3, a third pinion gear P3 composed of a pair of gears that mesh with the third sun gear S3 and the third ring gear R3, and a third carrier CA3 that supports the third pinion gear P3 in a manner as to allow rotation of the third pinion gear P3 around its own axis as well as an orbital revolution thereof.

The second carrier CA2 of the second planetary gear unit 38 and the third carrier CA3 of the third planetary gear unit 40 are composed of a common member, and the second ring gear R2 of the second planetary gear unit 38 and the third ring gear R3 of the third planetary gear unit 40 are composed of a common member. In addition, the second pinion gear P2 of the second planetary gear unit 38 is configured as a so-called ravigneaux-type gear train that functions as one of the pair of gears configuring the third pinion gear P3 of the third planetary gear unit 40. Hereinafter, the second carrier CA2 and the third carrier CA3 are referred to as a carrier RCA as a common member, and the second ring gear R2 and the third ring gear R3 are referred to as a ring gear RR as a common member.

The first sun gear S1 is coupled to a case 18 that is a non-rotary member. The first carrier CA1 is coupled to the transmission input shaft 32, and is also coupled to the second sun gear S2 via the fourth clutch C4. The first ring gear R1 is coupled to the third sun gear S3 via the first clutch C1, and is also coupled to the second sun gear S2 via the third clutch C3. The second sun gear S2 is coupled to the case 18 via the first brake B1. The carrier RCA is coupled to the transmission input shaft 32 via the second clutch C2, and is also coupled to the case 18 via the second brake B2. The carrier RCA is coupled to the case 18 via the one way clutch F1 arranged in parallel to the second brake B2. The ring gear RR is coupled to the transmission output shaft 24.

The aforementioned first clutch C1, second clutch C2, third clutch C3, fourth clutch C4, first brake B1, and second brake B2 (referred to simply as clutches C, brakes B, or engagement devices unless otherwise distinguished) are a hydraulic friction engagement device often used in a known vehicle automatic transmission, and are composed of wet-type multi dick clutches and brakes pushed by a hydraulic actuator, or handbrakes tightened by the hydraulic actuator. Each of the clutches C and the brakes B configured in such a manner is switched between engagement and disengagement by changing a torque capacity thereof (i.e. engagement force) by a not-shown hydraulic control circuit included in the automatic transmission 16.

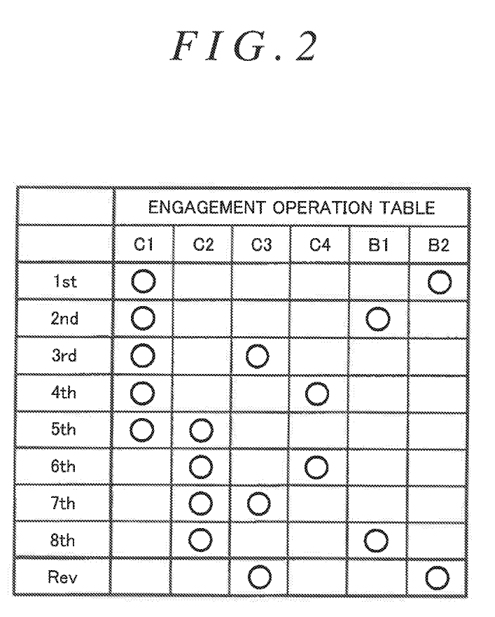

By controlling engagement and disengagement of the clutches C and the brakes B, as shown in an engagement operation table of FIG. 2, respective gear positions including eight forward gear positions and one reverse gear position are formed in accordance with the accelerator operation by a driver, a vehicle velocity V, and others. “1st” to “8th” in FIG. 2 denote the first shift position to the eight shift position as forward gear positions, and “Rev” denotes a reverse shift position as a backward gear position, and a gear ratio γ of the automatic transmission 16 corresponding to each shift position (=rotational speed of an input shaft of the transmission Nin/rotational speed of an output shaft thereof Nout) is appropriately defined depending on each gear ratio (=the number of teeth on the sun gear/the number of teeth on the ring gear) of the first planetary gear unit 36, the second planetary gear unit 38, and the third planetary gear unit 40.

As shown in the engagement operation table of FIG. 2, the first clutch C1 is brought to mesh with the second brake B2 so as to establish the first gear position “1st”. The first clutch C1 is brought to mesh with the first brake B1 so as to establish the second gear position “2nd”. The first clutch C1 is brought to mesh with the third clutch C3 so as to establish the third gear position “3rd”. The first clutch C1 is brought to mesh with the fourth clutch C4 so as to establish the fourth gear position “4th”. The first clutch C1 is brought to mesh with the second clutch C2 so as to establish the fifth gear position “5th”. The second clutch C2 is brought to mesh with the fourth clutch C4 so as to establish the sixth gear position “6th”. The second clutch C2 is brought to mesh with the third clutch C3 so as to establish the seventh gear position “7th”. The second clutch C2 is brought to mesh with the first brake B1 so as to establish the eighth gear position “8th”. The third clutch C3 is brought to mesh with the second brake B2 so as to establish the reverse gear position “Rev”.

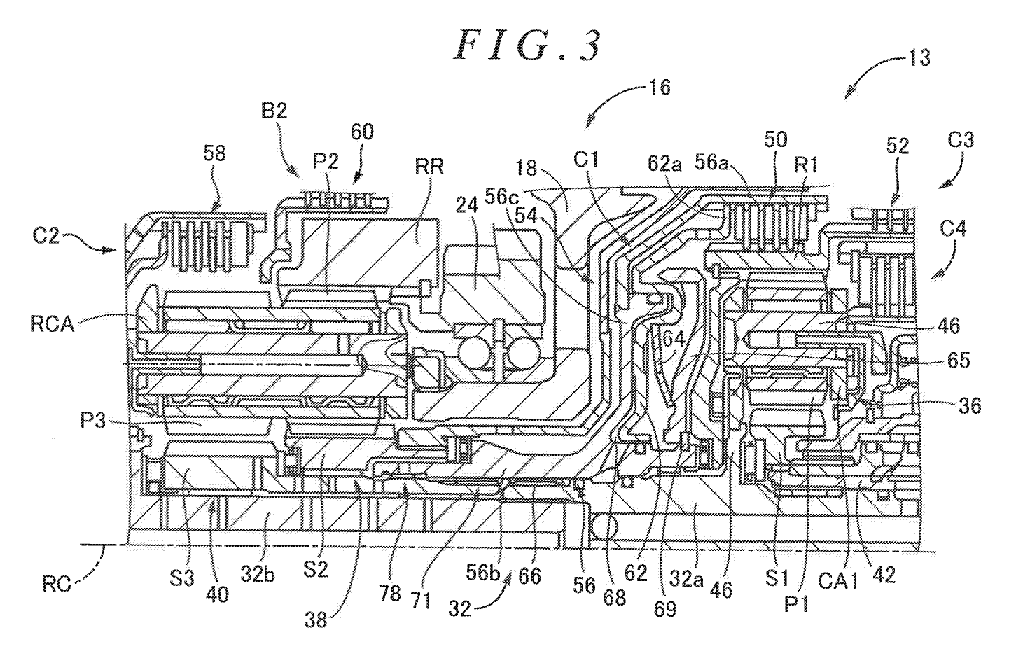

FIG. 3 is a cross-sectional view showing a part of the automatic transmission 16 configuring the vehicle power transmission system 13 of FIG. 1. The automatic transmission 16 is configured to include, in the case 18 as the non-rotary member, the transmission input shaft 32, the transmission output shaft 24, the first planetary gear unit 36, the second planetary gear unit 38, and the third planetary gear unit 40. Each of the transmission input shaft 32, the first planetary gear unit 36 to the third planetary gear unit 40 is configured to be substantially symmetric to the axial line RC; therefore, an illustration of lower half parts thereof from the axial line RC is omitted in FIG. 3.

The transmission input shaft 32 is so arranged as to be rotatable around the axial line RC. The transmission input shaft 32 is composed of a first rotational shaft 32a located closer to the torque converter 14 in the axial line RC direction (on the right side in FIG. 3) and a second rotational shaft 32b located farther apart from the torque converter 14 in the axial line RC direction (on the left side in FIG. 3). The first rotational shaft 32a and the second rotational shaft 32b are spline-fitted to each other so as to be integrally rotated around the axial line RC. An end portion of the first rotational shaft 32a located closer to the torque converter 14 in the axial line RC direction is power-transmissibly coupled to the turbine wheel 14t of the torque converter 14.

From the torque converter 14 side in the axial line RC direction, the first planetary gear unit 36, the second planetary gear unit 38, and the third planetary gear unit 40 are arranged in this order with the axial line RC as a central axis of each of them.

The first planetary gear unit 36 is composed of the double-pinion-type planetary gear unit. The first sun gear S1 of the first planetary gear unit 36 is coupled to an intermediate member 42 arranged on an outer circumference of the first rotational shaft 32a. The intermediate member 42 is coupled to the case 18 that is a non-rotary member. Therefore, the first sun gear S1 is so held as not to be rotatable all the time. The first carrier CA1 supports both ends of a pinion shaft 46 extending through the first pinion gear P1. The first carrier CA1 is coupled to a flange 46 of the first rotational shaft 32a, and is rotated together with the first rotational shaft 32a around the axial line RC. The first carrier CA1 is coupled to the fourth clutch C4. The first ring gear R1 is formed in an annular shape, and a friction engagement element 50 of the first clutch C1 and a friction engagement element 52 of the third clutch C3 are provided on an outer circumference of the first ring gear R1.

The second sun gear S2 of the second planetary gear unit 38 is formed in an annular shape, and is so provided as to be rotatable around the axial line RC. An external gear coming into mesh with the second pinion gear P2 is formed on an outer circumference of the second sun gear S2. Spline gear teeth (external circumferential teeth) are formed on an outer circumferential surface of the second sun gear S2 that is located closer to the torque converter 14 in the axial line RC direction, and are spline-fitted to internal circumferential spline teeth of a coupling drum 54. The coupling drum 54 is power-transmissibly coupled to the third clutch C3, the fourth clutch C4, and the first brake B1.

The third sun gear S3 of the third planetary gear unit 40 is formed in a substantially cylindrical shape, and an outer circumferential end portion thereof located closer to the torque converter 14 in the axial line RC is spline-fitted to a clutch drum 56 of the first clutch C1 described later. An external gear coming into mesh with the third pinion gear P3 is formed at an outer circumferential end portion of the third sun gear S3 that is located farther apart from the torque converter 14 in the axial line RC direction.

The carrier RCA common to both the second planetary gear unit 38 and the third planetary gear unit 40 supports the second pinion gear P2 and the third pinion gear P3 in a manner as to allow rotations of the second and third pinion gears P2, P3 around their own axes as well as orbital revolutions thereof. The ring gear RR common to both the second planetary gear unit 38 and the third planetary gear unit 40 is formed in an annular shape, and an inner circumference thereof is provided with an internal gear coming into mesh with the second pinion gear P2. The ring gear RR is so coupled to the transmission output shaft 24 as to be integrally rotatable. A friction engagement element 58 of the second clutch C2 and a friction engagement element 60 of the second brake B2 are arranged circumferentially outward of the second planetary gear unit 38 and the third planetary gear unit 40.

The first clutch C1 that provides connection or disconnection in the power transmission path between the third sun gear S3 and the first ring gear R1 is disposed between the third sun gear S3 and the first ring gear R1 of the first planetary gear unit 36. The first clutch C1 is configured to include the clutch drum 56, the friction engagement element 50 provided between the clutch drum 56 and the first ring gear R1, a piston 62 pushing the friction engagement element 50, a spring 64 urging the piston 62 in a direction apart from the friction engagement element 50 in the axial line RC direction, and a supporting member 65 disposed to face the piston 62 in the axial line RC direction so as to support the spring 64. The third sun gear S3 corresponds to a first rotary body of the present disclosure, the clutch drum 56 corresponds to a second rotary body of the present disclosure, and the first clutch C1 corresponds to a clutch of the present disclosure.

The clutch drum 56 is a cylindrical stepped member that includes a large-diameter cylindrical portion 56a, a small-diameter cylindrical portion 56b, and a disk portion 56c in a disk shape that couples the large-diameter cylindrical portion 56a and the small-diameter cylindrical portion 56b, and the clutch drum 56 is rotatably supported around the axial line RC.

The large-diameter cylindrical portion 56a of the clutch drum 56 is disposed circumferentially outward of the first ring gear R1, and the friction engagement element 50 formed by multiple friction plates is disposed between an inner circumferential surface of the large-diameter cylindrical portion 56a and an outer circumferential surface of the first ring gear R1. The friction engagement element 50 is formed by outer friction plates spline-fitted to the inner circumferential surface of the large-diameter cylindrical portion 56a and inner friction plates spline-fitted to the outer circumferential surface of the first ring gear R1, and the outer friction plates and the inner friction plates are alternately stacked one by one.

The small-diameter cylindrical portion 56b of the clutch drum 56 is disposed circumferentially outward of the transmission input shaft 32 and the third sun gear S3, and is rotatably supported via a roll bearing 66 or the like around the axial line RC. The disk portion 56c is a disk-shaped member whose inner circumferential portion is coupled to the small-diameter cylindrical portion 56b and whose outer circumferentially portion is coupled to the large-diameter cylindrical portion 56a, and the disk portion 56c is disposed between the coupling drum 54 and the piston 62 in the axial line RC.

The piston 62 is formed in a disk shape, and is disposed between the clutch drum 56 (disk portion 56c) and a supporting member 65 in the axial line RC. An inner circumferential end portion of the piston 62 is fitted to an outer circumferential surface of the small-diameter cylindrical portion 56b of the clutch drum 56 in such a manner as to be relatively moveable in the axial line RC direction. An outer circumferential end portion of the piston 62 is spline-fitted to the inner circumferential surface of the large-diameter cylindrical portion 56a of the clutch drum 56 so that the piston 62 is integrally rotated together with the clutch drum 56, and is allowed to relatively move in the axial line RC direction relative to the clutch drum 56. The piston 62 is provided with a pushing portion 62a at a position adjacent to the friction engagement element 50 in the axial line RC direction, and when the piston 62 moves toward the friction engagement element 50 in the axial line RC direction, the pushing portion 62a pushes the friction engagement element 50 so as to bring the first clutch C1 into an engagement state or a slip-engagement state. The piston 62 is moved in the axial line RC direction by supplying hydraulic fluid to an oil pressure chamber 68 that is an oil-tight space surrounded by the piston 62 and the clutch drum 56.

The spring 64 is inserted between the piston 62 and the supporting member 65 in the axial line RC direction with a load applied thereto, so that the piston 62 is always pushed in a direction apart from the friction engagement element 50 in the axial line RC direction. The supporting member 65 abuts to a snap ring 69 fitted to the outer circumferential surface of the small-diameter cylindrical portion 56b, thereby restricting movement of the supporting member 65 in a direction apart from the piston 62 in the axial line RC direction.

Next, a structure of a coupled part between the third sun gear S3 and the clutch drum 56 (small-diameter cylindrical portion 56b) will be described hereinafter. FIG. 4 is an enlarged cross-sectional view enlarging the coupled part between the third sun gear S3 and the clutch drum 56 in FIG. 3.

The transmission input shaft 32 is so disposed as to be rotatable around the axial line RC. The third sun gear S3 is disposed circumferentially outward of the transmission input shaft 32. The third sun gear S3 has a cylindrical shape, and is so supported as to be rotatable around the axial line RC via roll bearings 70a, 70b and others inserted between the outer circumferential surface of the transmission input shaft 32 and the inner circumferential surface of the third sun gear S3. The clutch drum 56 (small-diameter cylindrical portion 56b) is so supported as to be rotatable around the axial line RC via a roll bearing 66 and others inserted between the small-diameter cylindrical portion 56b and the transmission input shaft 32.

The third sun gear S3 and the clutch drum 56 are spline-fitted to each other at respective axial end portions thereof facing each other in the axial line RC direction. A fitting hole 71 is formed in a part of the clutch drum 56 that faces the third sun gear S3 in the axial line RC direction, and one end portion of the third sun gear S3 is fitted into the fitting hole 71. An axial end of the small-diameter cylindrical portion 56b of the clutch drum 56 whose diameter is larger than that of the third sun gear S3 is arranged circumferentially outward of the axial end portion of the third sun gear S3 located closer to the torque converter 14 in the axial line RC direction (on the right side in FIG. 4). Accordingly, the axial end portion of the third sun gear S3 located closer to the torque converter 14 in the axial line RC direction and the axial end portion of the small-diameter cylindrical portion 56b located closer to an opening of the fitting hole 71 in the axial line RC direction (on the left side in FIG. 4) partially overlap each other as viewed from the radial direction. Specifically, one end portion of the third sun gear S3 and one end portion of the clutch drum 56 that face each other partially overlap each other in the radial direction.

External circumferential spline teeth 72 are formed at an outer circumferential end portion of the third sun gear S3 located closer to the torque converter 14 in the axial line RC direction. Internal circumferential spline teeth 74 are formed on an inner circumferential surface of the clutch drum 56 (inner circumferential surface of the fitting hole 71) that overlap the external circumferential spline teeth 72 as viewed in the radial direction. A position where the internal circumferential spline teeth 74 are formed corresponds to a position in a part of the clutch drum 56 (small-diameter cylindrical portion 56b) that overlaps the third sun gear S3 in the radial direction (as viewed from the radial direction), this position being located farther apart from the opening of the fitting hole 71 (on the right side of FIG. 4) in the axial line RC direction. The external circumferential spline teeth 72 of the third sun gear S3 and the internal circumferential spline teeth 74 of the clutch drum 56 are spline-fitted to each other, thereby forming a spline-fitted part 76. The external circumferential spline teeth 72 correspond to external circumferential teeth of the present disclosure, and the internal circumferential spline teeth 74 correspond to internal circumferential teeth of the present disclosure.

In a part where the third sun gear S3 and the clutch drum 56 overlap each other in the radial direction, a tolerance ring 78 is disposed between the outer circumferential surface of the third sun gear S3 and the inner circumferential surface of the clutch drum 56 (small-diameter cylindrical portion 56b) with the tolerance ring 78 in contact with both the members. The tolerance ring 78 is disposed closer to the opening of the fitting hole 71 than to the spline-fitted part 76 in the axial line RC direction. In other words, when the third sun gear S3 is fitted into the fitting hole 71 of the clutch drum 56, the tolerance ring 78 is located in a more forward direction (on the left side of FIG. 4) than the spline-fitted part 76 in the (relatively) forward direction (in the leftward direction in FIG. 4) of assembling the clutch drum 56 to the third sun gear S3. By providing this tolerance ring 78, relative rotation between the external circumferential spline teeth 72 and the internal circumferential spline teeth 74 is suppressed by amount of a backlash caused therebetween in the rotational direction, thus suppressing teeth hammer due to a collision between teeth surfaces of the external circumferential spline teeth 72 and teeth surfaces of the internal circumferential spline teeth 74.

The tolerance ring 78 is housed in an annular groove 80 formed in the inner circumferential surface of the fitting hole 71 of the clutch drum 56. This annular groove 80 is also formed at a position more inward in the forward direction than the spline-fitted part 76 (internal circumferential spline teeth 74) in the (relatively) forward direction of assembling the clutch drum 56 to the third sun gear S3, that is, at a position in the clutch drum 56 located closer to the opening of the fitting hole 71 than to the spline-fitted part 76 (internal circumferential spline teeth 74) in the axial line RC direction after the assembly. The annular groove 80 is formed by a cutting tool that is inserted from the opening of the fitting hole 71 of the clutch drum 56.

The forward direction of assembling the clutch drum 56 to the third sun gear S3 is a relative moving direction of the clutch drum 56 relative to the third sun gear S3 when the third sun gear S3 is fitted into the fitting hole 71 of the clutch drum 56, and corresponds to a direction indicated by an arrow X in FIG. 4. The moving direction while the third sun gear S3 is assembled to the clutch drum 56 is a relative moving direction of the third sun gear S3 relative to the clutch drum 56 when the third sun gear S3 is fitted into the fitting hole 71 of the clutch drum 56, and corresponds to a direction indicated by an arrow Y in FIG. 4.

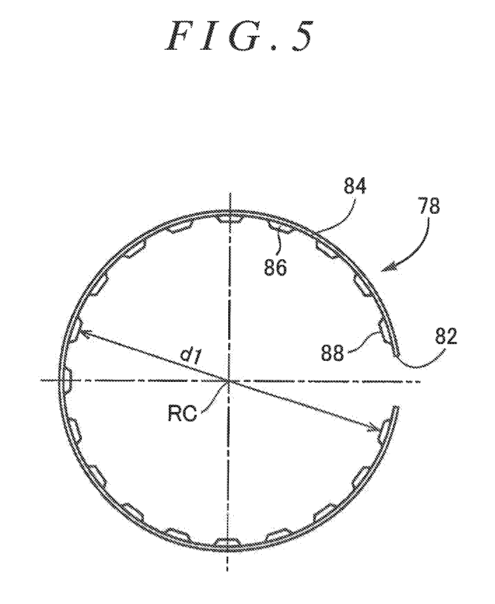

FIG. 5 is a view of the tolerance ring 78 of FIG. 4 as viewed from an arrow A direction in FIG. 4 (direction parallel to the axial line RC). The tolerance ring 78 is composed of a metallic elastic material, and is a substantially annular member having a cut-out 82 formed in a circumferential part of the tolerance ring 78. The tolerance ring 78 is composed of an annular portion 84 formed in a substantially annular shape, and multiple inward projections 86 projecting radially inward from an inner circumferential surface of the annular portion 84. The annular portion 84 has the cut-out 82 formed in a circumferential part thereof, and thus is elastically deformable. Accordingly, since the annular portion 84 is deformed, it is possible to previously fit the tolerance ring 78 into the annular groove 80 of the clutch drum 56. The inward projections 86 are arranged on the inner circumferential surface of the annular portion 84 with equal intervals in the circumferential direction. An outer circumferential surface of the annular portion 84 is in contact with the clutch drum 56 (annular groove 80) in an assembled state thereof In addition, a projecting surface 88 of each inward projection 86 is in contact with the outer circumferential surface of the third sun gear S3 in the assembled state thereof.

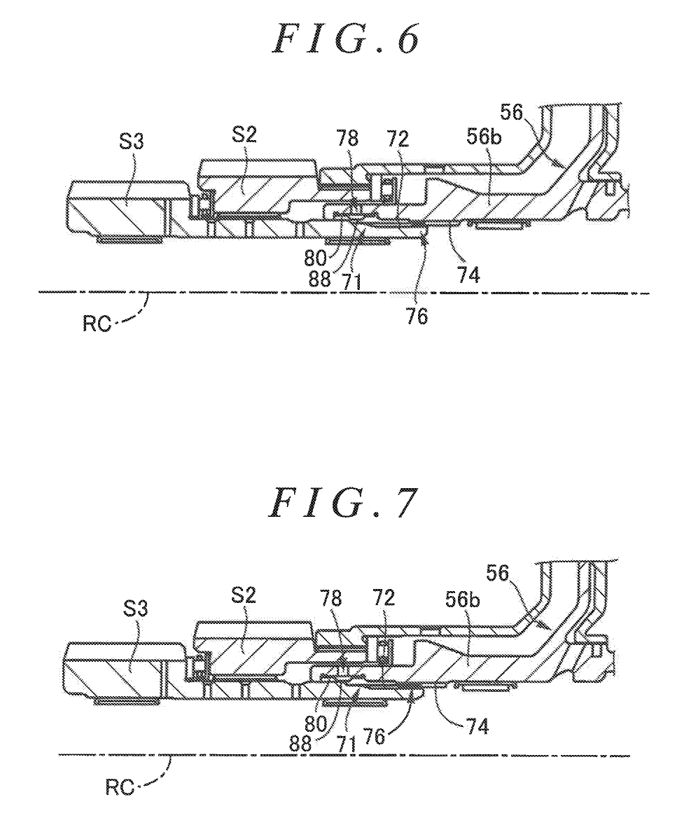

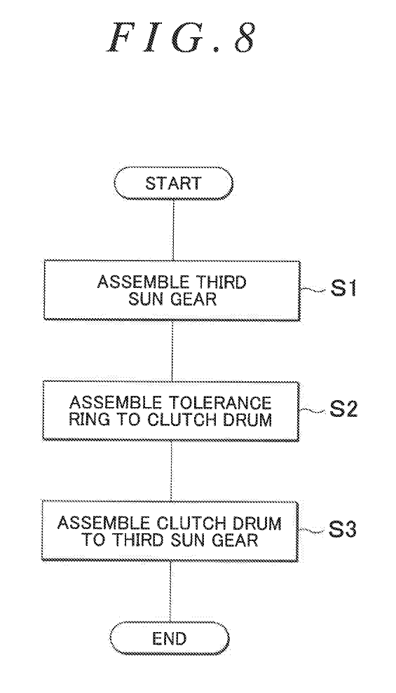

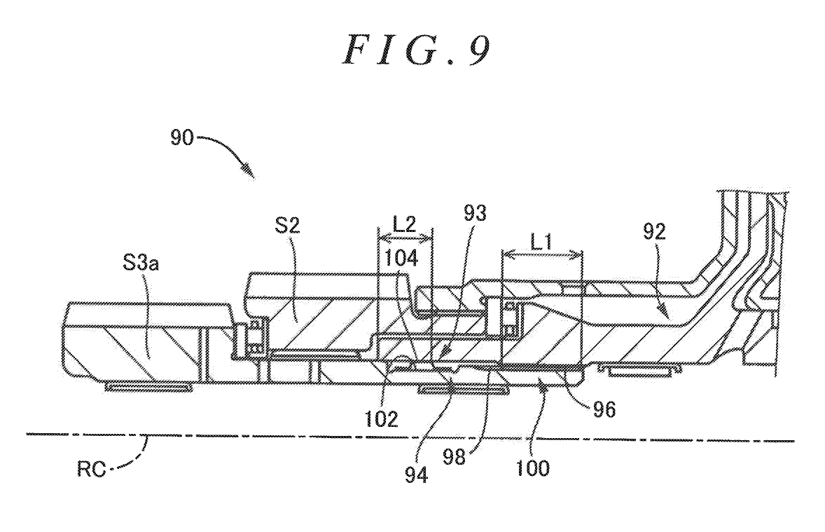

FIG. 6 and FIG. 7 respectively show relative positions of the third sun gear S3 and the clutch drum 56 in an assembly-transitional state thereof. FIG. 6 shows a state in which the external circumferential spline teeth 72 of the third sun gear S3 start meshing with the internal circumferential spline teeth 74 of the clutch drum 56, and FIG. 7 shows a state in which the projecting surfaces 88 of the tolerance ring 78 start coming into contact with the outer circumferential surface of the third sun gear S3. An inner diameter d1 of the tolerance ring 78 (see FIG. 5) is smaller than a diameter of a portion of the third sun gear S3 coming into contact with the projecting surfaces 88 of the tolerance ring 78; therefore, in the assembly-transitional state, when the projecting surfaces 88 of the tolerance ring 78 come into contact with the outer circumferential surface of the third sun gear S3, the inward projections 86 of the tolerance ring 78 become deformed. At this time, there is caused load (press-fitting load) due to the deformation of the tolerance ring 78.

If the clutch drum 56 moves in the forward direction of the assembly relative to the third sun gear S3, that is a direction coming closer to the third sun gear S3 in the axial line RC direction (the leftward direction in FIG. 6 and FIG. 7) while the tolerance ring 78 is previously fixed into the annular groove 80 of the clutch drum 56, the external circumferential spline teeth 72 of the third sun gear S3 start meshing with the internal circumferential spline teeth 74 of the clutch drum 56, as shown in FIG. 6. At this time, the projecting surfaces 88 of the tolerance ring 78 is not in contact with the outer circumferential surface of the third sun gear S3. FIG. 6 shows a state immediately before the projecting surfaces 88 of the tolerance ring 78 come into contact with the outer circumferential surface of the third sun gear S3, and at this time, the external circumferential spline teeth 72 of the third sun gear S3 come into a state of meshing with the internal circumferential spline teeth 74 of the clutch drum 56 by only approximately several mm (e.g., approximately 3 mm).

In this manner, the external circumferential spline teeth 72 previously mesh with the internal circumferential spline teeth 74 by approximately several mm before the tolerance ring 78 comes into contact with the outer circumferential surface of the third sun gear S3, thereby adjusting positions of both the axial centers of the third sun gear S3 and the clutch drum 56 so as to center the third sun gear S3 and the clutch drum 56.

After the external circumferential spline teeth 72 and the internal circumferential spline teeth 74 start meshing with each other, the clutch drum 56 further moves toward the third sun gear S3, and the projecting surfaces 88 of the tolerance ring 78 then start coming into contact with the outer circumferential surface of the third sun gear S3, as shown in FIG. 7. Accordingly, the tolerance ring 78 comes into contact with both the clutch drum 56 and the third sun gear S3. At this time, the external circumferential spline teeth 72 and the internal circumferential spline teeth 74 previously mesh with each other, thereby suppressing eccentricity between the third sun gear S3 and the clutch drum 56; therefore, when tolerance ring 78 comes into contact with the outer circumferential surface of the third sun gear S3 and becomes deformed, the inward projections 86 of the tolerance ring 78 become uniformly deformed in the circumferential direction, thus preventing load (reacting load) caused in the tolerance ring 78 from becoming ununiform in the circumferential direction. As a result, quality of the tolerance ring 78 after the assembly becomes stable. The centering between the third sun gear S3 and the clutch drum 56 is carried out when the external circumferential spline teeth 72 and the internal circumferential spline teeth 74 mesh with each other, and thus it becomes unnecessary to provide a structure for this centering in the assembly; therefore, the centering is feasible even if there is no space in the vicinity of the spline-fitted part 76. Accordingly, the manufacturing cost can be reduced. The respective inward projections 86 are uniformly deformed, thus reducing load (press-fitting load) applied during the assembly.

Here, in the assembly-transitional state, in order to bring the external circumferential spline teeth 72 and the internal circumferential spline teeth 74 to mesh with each other before the tolerance ring 78 comes into contact with the third sun gear S3, a length L1 in the axial line RC direction of a part where the external circumferential spline teeth 72 and the internal circumferential spline teeth 74 overlap each other as viewed from the radial direction (i.e. a length L1 in the axial line RC direction of a part where the external circumferential spline teeth 72 and the internal circumferential spline teeth 74 mesh with each other) after the assembly is set to be longer than a length L2 in the axial line RC direction of a part where the third sun gear S3 comes into contact with the projecting surfaces 88 of the tolerance ring 78 in the assembly-transitional state (L1>L2) (see FIG. 4). Preferably, the length L1 is set to be longer than the length L2 by at least approximately several mm. The length L2 corresponds to a distance in the axial line RC direction between a position of a part where the third sun gear S3 first comes into contact with the projecting surfaces 88 of the tolerance ring 78 in the assembly-transitional state and a position of the part where the third sun gear S3 is in contact with the projecting surfaces 88 of the tolerance ring 78 after the assembly, this position being located farthest in the part from the spline-fitted part 76 in the axial line RC direction. By respectively setting the length L1 and the length L2 in this manner, in the assembly-transitional state, the external circumferential spline teeth 72 and the internal circumferential spline teeth 74 are configured to come into mesh with each other before the projecting surfaces 88 of the tolerance ring 78 come into contact with the third sun gear S3.

FIG. 8 shows a flowchart explaining assembly steps of assembling the third sun gear S3 and the clutch drum 56. In a first step S1, the third sun gear S3 is assembled to the case 18. Subsequently, in a second step S2, the annular groove 80 is formed in the clutch drum 56 by cutting, and the tolerance ring 78 is then assembled into this annular groove 80. The second step S2 may be executed in a different manufacturing line.

In a third step S3, the third sun gear S3 is assembled to the clutch drum 56. The clutch drum 56 moves in parallel to the axial line RC toward the third sun gear S3 from a state in which the clutch drum 56 and the third sun gear S3 are so arranged as to have the axial line RC as the respective centers thereof. When the third sun gear S3 is fitted into the fitting hole 71 of the clutch drum 56, as shown in FIG. 6, the external circumferential spline teeth 72 of the third sun gear S3 start meshing with the internal circumferential spline teeth 74 of the clutch drum 56 before the projecting surfaces 88 of the tolerance ring 78 come into contact with the outer circumferential surface of the third sun gear S3. In this manner, the external circumferential spline teeth 72 and the internal circumferential spline teeth 74 mesh with each other, thereby centering the third sun gear S3 and the clutch drum 56, thus suppressing eccentricity of the third sun gear S3 and the clutch drum 56.

In addition, the third sun gear S3 moves toward the clutch drum 56, as shown in FIG. 7, the projecting surfaces 88 of the tolerance ring 78 start coming into contact with the outer circumferential surface of the third sun gear S3. At this time, as the projecting surfaces 88 of the tolerance ring 78 come into contact with the outer circumferential surface of the third sun gear S3, the respective inward projections 86 become gradually deformed; however, the third sun gear S3 and the clutch drum 56 are previously centered, and thus the respective inward projections 86 become deformed in a substantially uniform manner. Accordingly, quality of the tolerance ring 78 becomes stable after the assembly.

As aforementioned, according to the present embodiment, when the third sun gear S3 is fitted into the fitting hole 71 of the clutch drum 56, the external circumferential spline teeth 72 and the internal circumferential spline teeth 74 that configure the spline-fitted part 76 start meshing with each other before the tolerance ring 78 comes into contact with the third sun gear S3 and the clutch drum 56. Therefore, even if there is no space around the spline-fitted part 76 and machining for centering is difficult to be carried out, the external circumferential spline teeth 72 and the internal circumferential spline teeth 74 mesh with each other, thereby centering the third sun gear S3 and the clutch drum 56. Accordingly, it is possible to carry out an accurate assembly of the third sun gear S3 and the clutch drum 56 without causing eccentric thereof.

According to the present embodiment, because the tolerance ring 78 is housed in the annular groove 80 formed in the inner circumferential surface of the fitting hole 71 of the clutch drum 56, no annular groove is formed in the third sun gear S3. Accordingly, since the annular groove is formed in the third sun gear S3, the wall thickness of the third sun gear S3 is prevented from becoming thinner, and thus suppressing decrease in strength of the third sun gear S3. The annular groove 80 formed in the clutch drum 56 is formed at a position located closer to the opening of the fitting hole 71 than to the spline-fitted part 76, and thus almost no torque is transmitted to the part where the annular groove 80 is formed. Accordingly, even if the annular groove 80 is formed in the clutch drum 56, decrease in strength of the clutch drum 56 causes no problem.

According to the present embodiment, the length L1 in the axial line RC direction of the part where the external circumferential spline teeth 72 of the third sun gear S3 and the internal circumferential spline teeth 74 of the clutch drum 56 overlap each other as viewed from the radial direction after the assembly is longer than the length L2 in the axial line RC direction of the outer circumferential surface of the third sun gear S3 in contact with the projecting surfaces 88 of the tolerance ring 78 in the assembly-transitional state; thus, when the third sun gear S3 is fitted into the fitting hole 71 of the clutch drum 56, the external circumferential spline teeth 72 and the internal circumferential spline teeth 74 that configure the spline-fitted part 76 start coming into mesh with each other before the projecting surfaces 88 of the tolerance ring 78 come into contact with the outer circumferential surface of the third sun gear S3. Therefore, even if there is no space around the spline-fitted part 76 and machining for centering is difficult to be carried out, the external circumferential spline teeth 72 and the internal circumferential spline teeth 74 mesh with each other, thereby carrying out the centering of the external circumferential spline teeth 72 and the internal circumferential spline teeth 74. Accordingly, it is possible to carry out an accurate assembly of the third sun gear S3 and the clutch drum 56 without causing eccentric thereof.

Next, another embodiment of the present disclosure will be described. In the following description, the same reference numerals will be used for the portions common to the aforementioned embodiment, and description thereof will be omitted.

FIG. 9 is a cross-sectional view explaining a structure of a coupled part between a third sun gear 3a and a clutch drum 92 with which a vehicle power transmission system 90 as another embodiment of the present disclosure is provided, and corresponds to FIG. 4 of the aforementioned embodiment.

Compared with the aforementioned vehicle power transmission system 13, in the vehicle power transmission system 90 of the present embodiment, an annular groove 102 housing a tolerance ring 93 therein is formed in the third sun gear S3a. Hereinafter, a structure different from that of the vehicle power transmission system 13 of the aforementioned embodiment will be described.

A fitting hole 94 is formed in a clutch drum 92, and one end portion of the third sun gear S3a is fitted into this fitting hole 94. Hence, the third sun gear S3a and the clutch drum 92 partially overlap each other as viewed from the radial direction, and the clutch drum 92 is disposed circumferentially outward of the third sun gear S3a. The third sun gear S3a corresponds to the first rotary body of the present disclosure, and the clutch drum 92 corresponds to the second rotary body of the present disclosure.

In a part where the third sun gear S3a and the clutch drum 92 overlap each other in the radial direction (as viewed from the radial direction), on the opposite side to the opening of the fitting hole 71 in the axial line RC direction (on the right side in the drawing), internal circumferential spline teeth 96 are formed. At an outer circumferential end portion of the third sun gear S3a that is fitted into the fitting hole 71, the outer circumferential spline teeth 98 to come into mesh with inner circumferential spline teeth 96 are formed. These internal circumferential spline teeth 96 and external circumferential spline teeth 98 are spline-fitted to each other, thereby forming a spline-fitted part 100. The internal circumferential spline teeth 96 correspond to the internal circumferential teeth of the present disclosure, and the external circumferential spline teeth 98 correspond to the external circumferential teeth of the present disclosure.

The tolerance ring 93 is arranged adjacent to the spline-fitted part 100 in the axial line RC direction. The tolerance ring 93 is disposed between an outer circumferential surface of the third sun gear S3a and an inner circumferential surface of the clutch drum 92, and also at a position in the part where the third sun gear S3a and the clutch drum 92 overlap each other in the radial direction, this position being located farther apart from an axial end of the third sun gear S3a fitted in the fitting hole 71 in the axial line RC direction.

In the present embodiment, the annular groove 102 is formed in the outer circumferential surface of the third sun gear S3a, and the tolerance ring 93 is housed in an annular space formed by this annular groove 102. The tolerance ring 93 of the present embodiment is provided with multiple outward projections that project radially outward from the outer circumferential surface of the annular portion, and are arranged with intervals in the circumferential direction. The inner circumferential surface of the annular portion comes into contact with the outer circumferential surface (annular groove 102) of the third sun gear S3a, and projecting surfaces 104 of the outward projections come into contact with the inner circumferential surface of the clutch drum 92.

In the present embodiment, it is configured that when the third sun gear S3a and the clutch drum 92 are assembled, the external circumferential spline teeth 98 of the third sun gear S3a previously mesh with the internal circumferential spline teeth 96 of the clutch drum 92 before the projecting surfaces 104 of the tolerance ring 93 come into contact with the inner circumferential surface of the clutch drum 92. With this configuration, before the projecting surfaces 104 of the tolerance ring 93 come into contact with the clutch drum 92, and thus become deformed, the external circumferential spline teeth 98 and the internal circumferential spline teeth 96 mesh with each other so as to previously center the third sun gear S3a and the clutch drum 92; and when the tolerance ring 93 comes into contact with the clutch drum 92, the respective outward projections of the tolerance ring 93 become uniformly deformed. Accordingly, even after the assembly, the quality of the tolerance ring 93 becomes stable, thus attaining the same effect as that of the aforementioned embodiment.

In order to bring the external circumferential spline teeth 98 and the internal circumferential spline teeth 96 to mesh with each other before the projecting surfaces 104 of the tolerance ring 93 come into contact with the clutch drum 92, a length L1 in the axial line RC direction of a part where the external circumferential spline teeth 98 and the internal circumferential spline teeth 96 overlap each other (i.e. a length L1 in the axial line RC direction of a part where the external circumferential spline teeth 98 and the internal circumferential spline teeth 96 mesh with each other) as viewed from the radial direction after the assembly is set to be longer than a length L2 in the axial line RC direction of a part where the clutch drum 92 is in contact with the projecting surfaces 104 of the tolerance ring 93 in the assembly-transitional state (L2<L1) (see FIG. 9). The length L2 corresponds to a length in the axial line RC direction between an opening end portion of the fitting hole 94 of the clutch drum 92 and an end portion of the part where the projecting surfaces 104 of the tolerance ring 93 are in contact with the clutch drum 92 after the assembly, this end portion being located closer to the spline-fitted part 100 in the axial line RC direction. By setting the lengths L1, L2 in this manner, before the projecting surfaces 104 of the tolerance ring 93 come into contact with the clutch drum 92 in the assembly-transitional state, the external circumferential spline teeth 98 come into mesh with the internal circumferential spline teeth 96.

As aforementioned, the embodiments of the present disclosure have been described in details based on the drawings, and the present disclosure is also applied to other aspects.

For example, in the aforementioned embodiments, the spline-fitted part 76 and the tolerance ring 78 are provided between the third sun gear S3 and the clutch drum 56, but the present disclosure is not always limited to the part between the third sun gear S3 and the clutch drum 56. The present disclosure may be appropriately applied to any part including a spline-fitted part formed by spline-fitting two rotary bodies to each other.

The above descriptions are merely one embodiment, and the present disclosure can be implemented in variously modified and improved forms based on the knowledge of those skilled in the art.

What is claimed is:

1. A manufacturing method for a vehicle power transmission system,
the vehicle power transmission system including
a first rotary body configured to rotate around an axial line, and
a second rotary body including a fitting hole into which one end portion of the first rotary body is fitted,
the second rotary body being configured to rotate around the axial line,
the first rotary body and the second rotary body being configured such that external circumferential teeth provided on an outer circumferential surface of the first rotary body and internal circumferential teeth provided on an inner circumferential surface of the fitting hole are spline-fitted to each other at a spline-fitted part,
the manufacturing method comprising:
disposing a tolerance ring at a position closer to an opening of the fitting hole than to the spline-fitted part in a forward direction of assembling the second rotary body to the first rotary body when the first rotary body is fitted into the fitting hole of the second rotary body; and
bringing the tolerance ring to come into contact with the first rotary body and the second rotary body after the external circumferential teeth of the first rotary body and the internal circumferential teeth of the second rotary body mesh with each other, in a transitional state in which the first rotary body is fitted into the fitting hole of the second rotary body.

2. A vehicle power transmission system comprising:
a first rotary body configured to rotate around an axial line;
a second rotary body including a fitting hole into which one end portion of the first rotary body is fitted, the second rotary body being configured to rotate around the axial line, the first rotary body and the second rotary body being configured such that external circumferential teeth provided on an outer circumferential surface of the first rotary body and internal circumferential teeth provided on an inner circumferential surface of the fitting hole are spline-fitted to each other at a spline-fitted part; and
a tolerance ring provided between the outer circumferential surface of the first rotary body and an inner circumferential surface of the second rotary body, the tolerance ring being located at a position closer to an opening of the fitting hole than to the spline-fitted part in an axial line direction,
a length in the axial line direction of a part where the external circumferential teeth and the internal circumferential teeth overlap each other as viewed from a radial direction being longer than a length in the axial line direction of the outer circumferential surface of the first rotary body or the inner circumferential surface of the second rotary body that come into contact with the tolerance ring.

3. The vehicle power transmission system according to claim 2, wherein
the tolerance ring is housed in an annular groove provided in the inner circumferential surface of the fitting hole of the second rotary body.

4. The vehicle power transmission system according to claim 2, wherein
the vehicle power transmission system includes a first planetary gear unit, a second planetary gear unit, and a third planetary gear unit,
the first planetary gear unit, the second planetary gear unit, and the third planetary gear unit are configured to rotate around a common axial line,
the second planetary gear unit and the third planetary gear unit constitute a ravigneaux planetary gear including a carrier that serves as a carrier of the second planetary gear and a carrier of the third planetary gear and a ring gear that serves as a ring gear of the second planetary gear and a ring gear of the third planetary gear,
a clutch is provided between a ring gear of the first planetary gear unit and a sun gear of the third planetary gear unit,
the spline-fitted part is provided between the sun gear and a clutch drum of the clutch,
the first rotary body is the sun gear, and
the second rotary body is the clutch drum.
